(19) United States
(12) Patent Application Publication
(10) Pub. No.: US 2022/0158534 A1
(43) Pub. Date: May 19, 2022

(54) ELECTROMAGNETIC BRAKE FOR A MOLD OF A SLAB CONTNUOUS CASTING ASSEMBLY

(71) Applicant: Primetals Technologies Austria GmbH, Linz (AT)

(72) Inventors: Martin HIRSCHMANNER, Leonding (AT); Felix LINDLBAUER, Linz (AT); Peter Paul WIMMER, Leonding (AT)

(21) Appl. No.: 17/438,502

(22) PCT Filed: Mar. 2, 2020
(86) PCT No.: PCT/EP2020/055453

§ 371 Date: Sep. 13, 2021

(30) Foreign Application Priority Data
Mar. 18, 2019 (EP) 19163442.7

(51) Int. Cl. H02K 49/04

(52) U.S. Cl. CPC H02K 49/046

(57) ABSTRACT

An electromagnetic brake that variably influences the flow of molten steel in two width regions (B1, B2) of a mold (1) of a slab continuous casting assembly by variably adjusting the magnetic flux density in the two width regions with two magnetic circuits, each magnetic circuit having a first pole (4a), a second pole (4b), and a yoke (2) for magnetically connecting the first and the second pole (4a, 4b). The first and the second poles (4a, 4b) lie substantially opposite each other in the direction of thickness (d) of the mold (1), and the first pole (4a) extends in the direction of the second pole (4b) in the direction of thickness (d) and vice versa. At least one pole (4a, 4b) of either magnetic circuit can be moved relative to the yoke (2) in the direction of thickness (d) of the mold (1).

### RELATED APPLICATIONS

This is a national phase application of PCT application PCT/EP2020/055453 filed on Mar. 2, 2020, which claims priority to European patent application EP19163442 filed Mar. 18, 2019, the content of which are incorporated by reference. The PCT International Application was published in the German language.

### FIELD OF INVENTION

The present invention relates to the technical field of continuous casting. In continuously operated continuous casting assemblies, the majority of the quantity of annually produced world steel is cast into strands with different cross-sections (slabs, thin slabs, billets, blooms, etc.). In slab continuous casting assemblies in particular, so-called electromagnetic brakes are used in the region of the mold to keep the casting level steady and reduce the number of non-metallic inclusions in the melt.

### BACKGROUND

Electromagnetic brakes for slab continuous casting assemblies are known in principle.

FIG. 1 shows a section through a mold 1 of a slab continuous casting assembly, wherein molten steel is fed into the mold cavity of the mold 1 via a submerged entry nozzle (SEN) 7. On the left half-plane of the figure, an electromagnetic brake is active; on the right half-plane, the electromagnetic brake is inactive. The main flow directions of the molten steel are indicated by arrows. In the left half-plane, the braking effect of the electromagnetic brake results in a steady casting level, wherein the flow velocities in the region of the casting level are between 0 and 0.12 m/s. By contrast, the flow velocities in the region of the casting level in the right half-plane are between 0 and 0.68 m/s. In addition, there is a pronounced upward flow along the narrow side plate in the right half-plane (vertical arrow pointing upward). Due to the unsteady casting level and the upward flow, casting powder is carried downwards from the casting level, contaminating the molten steel and the continuously cast strand.

FIG. 2 shows a plan view of a first design of an electromagnetic brake according to the prior art. Here, a magnetic field (represented by the field line F) is impressed into the mold 1 of a slab continuous casting assembly via four coils 3a to 3d through which current flows. The magnetic flux brakes the exit of metallic melt (generally a molten steel) from the submerged entry nozzle, not shown here, which has an advantageous effect on the product quality of the continuously cast strand. The design of the electromagnetic brake according to FIG. 2 is relatively complex, since four coils 3a. . . 3d, four poles 4a, 4b and two yokes 2 are required to form a single magnetic circuit.

In the embodiment according to FIG. 3, two magnetic circuits (represented by the field lines F₁, F₂) are formed by two coils 3a, 3b and two poles 4a, 4b. The field lines in the magnetic circles are guided in yokes 2 along the broad-side plates of the mold on the one hand and through the poles 4a, 4b on the other hand. Since the mold 1 and the electromagnetic brake are symmetrical, the magnetic flux in the first magnetic circuit along the field line F₁ is the same as the magnetic flux in the second magnetic circuit along the field line F₂. The magnetic flux densities in the two magnetic circuits F₁, F₂ are not trimmable during operation of the mold 1 or the continuous casting assembly. By trimming the two magnetic circuits, for example, the magnetic flux density in the first magnetic circuit F₁ could be set higher than in the second magnetic circuit F₂, or vice versa.

A disadvantage of the known electromagnetic brakes is that the magnetic flux density in a first width region B₁ of the mold 1 cannot be set differently from the magnetic flux density in a second width region B₂. Thus, trimming of the magnetic flux densities is not possible.

It is not apparent from the prior art how known electromagnetic brakes can be modified to allow variable adjustment of the magnetic flux densities in different width regions of the mold.

### SUMMARY OF THE INVENTION

The object of the invention is to modify a known electromagnetic brake so that the magnetic flux density in a first width region of the mold can be set differently from a magnetic flux density in a second width region of the same mold, wherein the two width regions are offset from each other in the width direction of the mold.

This object is achieved by the electromagnetic brake as claimed. Advantageous embodiments are the subject of the dependent claims.

Specifically, the solution is provided by an electromagnetic brake suitable for variably influencing the flow of a molten steel in a first and a second width region of a mold of a slab continuous casting assembly. The electromagnetic brake according to the invention comprises:
a first magnetic circuit for influencing the flow in the first width region of the mold,
a second magnetic circuit for influencing the flow in the second width region of the mold, wherein the second width region is offset from the first width region in the width direction of the mold, and
at least one coil, preferably at least two coils, for introducing a magnetic flux into the first and the second magnetic circuit,

wherein the first and second magnetic circuits each comprise
a first pole,
a second pole, and
a yoke for magnetic connection of the first and the second pole,

wherein the first and second poles are substantially opposite in the thickness direction of the mold, and the first pole extends in the thickness direction toward the second pole, and vice versa, and

wherein at least one pole of the first or second magnetic circuit, preferably at least one pole of the first and second magnetic circuit, is displaceable relative to the yoke of the same magnetic circuit in the thickness direction of the mold.

The melt, typically a molten steel, can be variably influenced in the first and second width regions of the mold by the first and second magnetic circuits. A variable influence shall be understood to mean that the melt can be slowed down in the first width region to a different extent than in the second width region, i.e. more strongly or more weakly in the first width region than in the second width region. For example, the first width region may be associated with the left side of the strand in the casting direction and the second width region may be associated with the right side of the strand in the casting direction. Investigations by the applicant have shown that the melt leaving the submerged entry nozzle on the left side of the mold behaves differently under certain operating conditions than the same melt leaving the submerged entry nozzle on the right side. Thus, it has become desirable to create an electromagnetic brake in which the melt can be braked to different degrees in different width regions. To this end, the electromagnetic brake comprises at least one coil, preferably two or four coils, through which a current flows and through which a magnetic flux can be introduced into the first and second magnetic circuits. In addition, each magnetic circuit comprises at least a first (magnetic) pole, a second (magnetic) pole, and a yoke for magnetically connecting the first and second poles. In each magnetic circuit, the first pole and the second pole of the same magnetic circuit are substantially opposite each other in the thickness direction of the mold, and one pole extends in the thickness direction of the mold in the direction of the other pole, and vice versa.

Advantageously, the yokes and poles of a magnetic circuit are made of a ferrous material such as steel. In order to keep the hysteresis losses small, these components can be “plated”.

In order to be able to impress the strongest possible magnetic field into the magnetic circuits, it is advantageous if the first and second magnetic circuits each comprise at least two separately energizable coils. The magnetic flux density can be adjusted in a first way by the energization of the coil or coils.

For an adjustment of the magnetic flux density in a magnetic circuit, it is provided in accordance with the invention that at least one pole of the first or second magnetic circuit, preferably at least one pole of the first and the second magnetic circuit, particularly preferably two poles of the first and the second magnetic circuit, is designed to be displaceable relative to the yoke in the thickness direction of the mold. The magnetic flux density can be adjusted in a second way via the air gap between a pole and the mold.

In order to be able to change the magnetic flux density during operation, it is advantageous to provide an actuator for displacing the pole in the thickness direction of the mold. The actuator can be, for example, a hydraulic, pneumatic or electromechanical linear drive. According to one embodiment, the linear drive can be displacement-controlled. According to an alternative embodiment, the linear drive can be moved between at least two positions (e.g., a first (starting) position and a second (end) position). As described above, the air gap between a pole and the mold or the air gaps between the poles of a magnetic circuit and the mold can be used to adjust the magnetic flux density and thus the braking effect.

Another possibility for adjusting a magnetic flux density in a magnetic circuit is that at least one pole of the first or second magnetic circuit, preferably at least one pole of the first and second magnetic circuits, particularly preferably two poles each of the first and second magnetic circuit, has a pole head which is detachably connected to the pole. In this case, the magnetic flux density is adjusted in a third way via the air gap between the pole head and the mold.

The adjustment of the magnetic flux density in a magnetic circuit in the first, second and third way can be combined arbitrarily. For example, a magnetic flux density can be introduced into the first and the second magnetic circuit via a plurality of coils each, e.g., two or four coils each. The flux densities can be influenced by the current applied to the coils and the distances between the poles and the mold. In addition, the flux density in a magnetic circuit can be changed via pole heads.

In order to be able to set the magnetic flux density in a magnetic circuit differently locally (i.e. in a certain width or height region of the pole head), it is advantageous if the pole head (relative to a narrow- or broad-side plate of the mold) extends in some sections in the width and/or height direction of the mold to a different extent in the thickness direction of the mold. Due to the different extension in some sections, the magnetic flux density is set differently locally.

In order to be able to vary the magnetic flux density locally as required, it is advantageous if the pole head is formed from a plurality of discrete elements. The discrete elements can be connected mechanically (e.g., by screwing or plugging) to a base surface (e.g., the end face of a pole or a separate base plate which is connected to the pole). In this way, the pole head can be formed “in relief”, wherein it is of course not necessary for the base surface to be fully equipped with elements. The elements can be all of the same length but also of different lengths. Preferably, the elements are made of steel.

In a space-saving arrangement, the yoke extends in the thickness direction of the mold. Typically, the yoke runs parallel to the narrow-side plate of the mold. Since the yoke guides the magnetic flux, it is not necessary for the yoke to run exactly in the thickness direction of the mold.

In principle, the electromagnetic brake according to the invention is not limited to two different width regions. For example, three or >3 magnetic circuits can also be provided in a plane normal to the casting direction.

In order to be able to influence the melt in different layers below the casting level, it is advantageous if the mold comprises a second magnetic brake which has a height offset from the first magnetic brake.

In addition, the electromagnetic brake according to the invention is not limited to 1 or 2 different height regions. For example, 3 or >3 magnetic brakes can also be arranged at different heights in each case.

The technical problem is also solved by the claimed methods. Advantageous embodiments of the invention are again the subject of the dependent claims.

Specifically, the technical problem is solved by a method for variably influencing the flow of a molten steel in a first and a second width region of a mold of a slab continuous casting assembly by means of an electromagnetic brake according to the invention, wherein the first and the second magnetic circuit each comprise at least one separately energizable coil, characterized by the method steps:
introducing a first magnetic flux into the first magnetic circuit by energizing a first coil with a first current, thereby influencing the flow in the first width region, and
introducing a second magnetic flux into the second magnetic circuit by energizing a second coil with a second current, thereby influencing the flow in the second width region,
wherein the first current is of a different strength than the second current,
wherein at least one pole of the first or second magnetic circuit, preferably at least one pole of the first and second magnetic circuit, is designed to be displaceable relative to the mold in the thickness direction thereof, and
wherein an air gap between a pole and the mold in the first magnetic circuit is set to be of a different size than an air gap between a pole and the mold in the second magnetic circuit.

According to this embodiment, the magnetic flux densities in the magnetic circuits are set electrically on the one hand by energizing the coils to different degrees.

On the other hand or in addition to the electrical setting of the magnetic flux densities, it is provided in accordance with the invention to adjust a magnetic flux density also via the setting of the air gaps. In this case, the electromagnetic brake has at least one pole of the first or second magnetic circuit, preferably at least one pole of the first and second magnetic circuits, which is designed to be displaceable relative to the mold in the thickness direction thereof. In this case, an air gap between a pole or a pole head and the mold in the first magnetic circuit is set to a different size than an air gap between a pole or pole head and the mold in the second magnetic circuit.

Furthermore, the technical problem is solved by a method for variably influencing the flow of a molten steel in a first and a second width region of a mold of a slab continuous casting assembly by means of an electromagnetic brake according to the invention, wherein at least one pole of the first or second magnetic circuit, preferably at least one pole of the first and second magnetic circuit, is designed to be displaceable relative to the mold in the thickness direction thereof, characterized by the method steps:
introducing a first magnetic flux into the first magnetic circuit by energizing a first coil with a first current, thereby influencing the flow in the first width region, and
introducing a second magnetic flux into the second magnetic circuit by energizing a second coil with a second current, thereby influencing the flow in the second width region,
wherein an air gap between a pole or pole head and the mold in the first magnetic circuit is set to be of a different size than an air gap between a pole or pole head and the mold in the second magnetic circuit.

According to this embodiment, the magnetic flux densities in the magnetic circuits are set by setting the air gaps.

In addition to adjusting magnetic flux densities by the setting of the air gaps, it may be advantageous to also adjust a magnetic flux density electrically.

To trim the magnetic flux densities in the two width regions of the mold, it is provided that an air gap between a pole or a pole head and the mold in the first magnetic circuit is of a different size from an air gap between a pole or a pole head and the mold in the second magnetic circuit.

In addition, it may be expedient if a local air gap between a pole head and the mold in the first magnetic circuit is of a different size than a local air gap between a pole head and the mold in the second magnetic circuit.

It is advantageous if the following method steps are additionally carried out when carrying out the method according to the invention:
detecting the flow velocities of the molten steel in the first and second width regions of the mold;
if the flow velocity of the molten steel in the first width region is higher than in the second width region: increasing the magnetic flux density in the magnetic circuit associated with the first width region;
OR
if the flow velocity of the molten steel in the first width region is higher than in the second width region: reducing the magnetic flux density in the magnetic circuit associated with the second width region.

The flow velocities of the molten steel in the first and second width regions of the mold are either measured directly (e.g., by measuring the flow velocities at the casting level) or indirectly (e.g., by evaluating temperature information from the mold) or are recorded by evaluating a computer model. If the flow velocity of the molten steel in the first width region B₁ of the mold is higher than in the second width region B₂, the magnetic flux density in the magnetic circuit associated with the first width region is increased. Alternatively or additionally, the magnetic flux density in the magnetic circuit associated with the second width region B₂ of the mold can also be reduced.

The increase or the reduction of the flux densities can be achieved by the above-mentioned method steps (first, second and/or third way).

### BRIEF DESCRIPTION OF THE DRAWINGS

Further advantages and features of the present invention will become apparent from the following description of non-limiting exemplary embodiments, wherein the following figures show:

FIG. 1 a section through a mold filled with molten steel and having an active or inactive electromagnetic brake according to the prior art,

FIG. 2 a plan view of a mold having a first electromagnetic brake according to the prior art,

FIG. 3 a plan view of a mold having a second electromagnetic brake according to the prior art,

FIG. 4 a plan view of a mold having an electromagnetic brake not according to the invention,

FIG. 5 a plan view of a mold having a first electromagnetic brake according to the invention,

FIG. 6 a plan view of a mold having a second electromagnetic brake according to the invention,

FIG. 7 a plan view of a mold having a third electromagnetic brake according to the invention,

FIG. 8 a plan view of a mold having a fourth electromagnetic brake according to the invention,

FIG. 9 a plan view of a mold having a fifth electromagnetic brake according to the invention,

FIGS. 10a to 10d each a perspective view of a pole head,

FIG. 11 a front view and a plan view of a mold having an electromagnetic brake according to the invention,

FIG. 12 a front view of a variant of the electromagnetic brake according to FIG. 11.

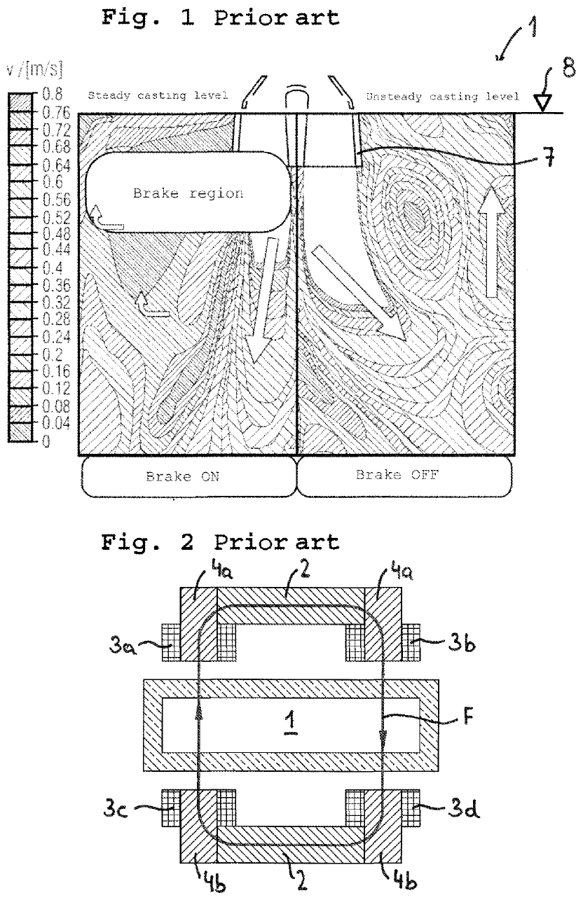

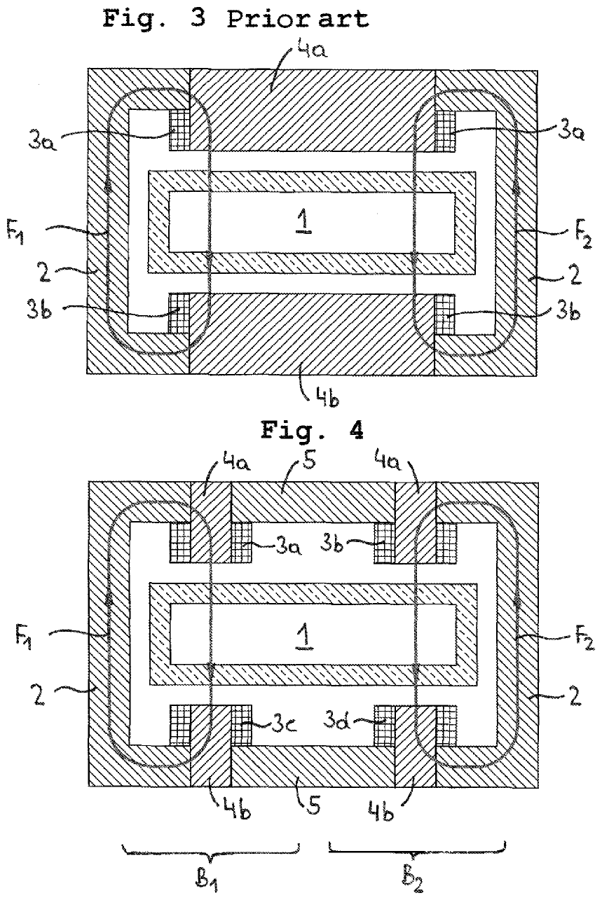

### DETAILED DESCRIPTION OF THE EMBODIMENTS

In the figures, the same reference signs are assigned to the same component parts or groups.

FIG. 4 shows a schematic diagram of a design, not according to the invention, of an electromagnetic brake for a slab mold, in particular a thin-slab mold, of a continuous casting assembly. In a central region between the first and second width regions B₁, B₂ of the mold 1, molten steel is fed into the mold 1 through a submerged entry nozzle, not shown here. Further details regarding the introduction of molten steel and regarding the fluid-mechanical phenomena can be found, for example, in Chapter 10.3 Electromagnetic Equipment for Slabs from the reference book
The Making, Shaping and Treating of Steel, The AISE Steel Foundation, 11^{th} edition, 2003.

According to FIG. 4, in a first width region B₁ of the mold 1, a magnetic flux (represented by the magnetic field line F₁) is introduced into the mold 1 by two coils 3a, 3c and two poles 4a, 4b. The magnetic flux F₁ influences the melt in the first width region, generally slowing it down. In an analogous manner, another magnetic flux (represented by the magnetic field line F₂) is introduced into a second width region B₂ of the mold 1 by two further coils 3b, 3d and two further poles 4a, 4b. The magnetic flux F₂ can influence the melt in the second width region. The (electro)magnetic flux density in the first width region B₁ is set by the energization of the coils 3a, 3c; the magnetic flux density in the second width region B₂ is set by the energization of the coils 3b, 3d. Thus, the magnetic flux F₁, F₂ in the respective width regions B₁, B₂ of the mold 1 can be set via the current supplied to the coils 3a. . . 3d and/or the number of turns of the coils. Theoretically, it is possible that instead of two coils 3a, 3c or 3b, 3d per magnetic circuit, there is also only one coil provided (e.g., 3a or 3d). Likewise, in the embodiment according to FIG. 4, it is possible to set the directions of the magnetic fluxes in the two width regions B₁, B₂ differently, so that, for example, the field line F₁ penetrates the mold 1 in the first width region B₁ from top to bottom and the field line F₂ penetrates the mold 1 in the second width region B₂ from bottom to top.

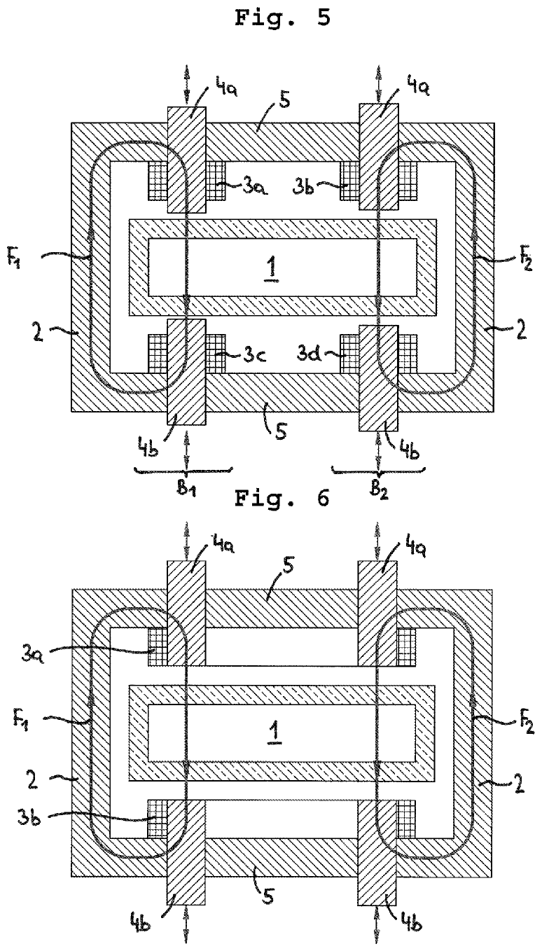

FIG. 5 schematically shows a first design, according to the invention, of an electromagnetic brake for a slab mold of a continuous casting assembly. In contrast to FIG. 4, at least one pole 4a, 4b is designed to be displaceable relative to the associated yoke 2. As shown, both poles 4a, 4b associated with the left width region B₁ are each designed to be displaceable relative to the left yoke 2. In addition, both poles 4a, 4b associated with the right-hand width region B₂ are also each designed to be displaceable relative to the right-hand yoke 2. Due to the displaceability of at least one pole 4a, 4b, the air gap between the pole 4a, 4b and the mold 1 can be varied, so that the magnetic flux density F₁ in the left width region B₁ can be set to be stronger or weaker than the magnetic flux density F₂ in the right width region B₂. To enable trimming of the magnetic flux densities during operation, an actuator is associated with at least one pole and can displace the pole. The displacement direction of the poles 4a, 4b is indicated by arrows in FIGS. 5 to 9 and 11. Thus, in the embodiment of FIG. 5, the magnetic flux densities F₁, F₂ can be adjusted by displacing at least one pole 4a, 4b. If necessary, the coils 3a, 3c or 3b, 3d can additionally be energized differently.

FIG. 6 shows a simplified embodiment of the electromagnetic brake of FIG. 5. In contrast to FIG. 5, the simplified embodiment has only a single coil 3a above the mold 1 and only a single coil 3b below the mold 1. Accordingly, in this embodiment, the magnetic flux densities F₁, F₂ can be adjusted only by moving at least one pole 4a, 4b.

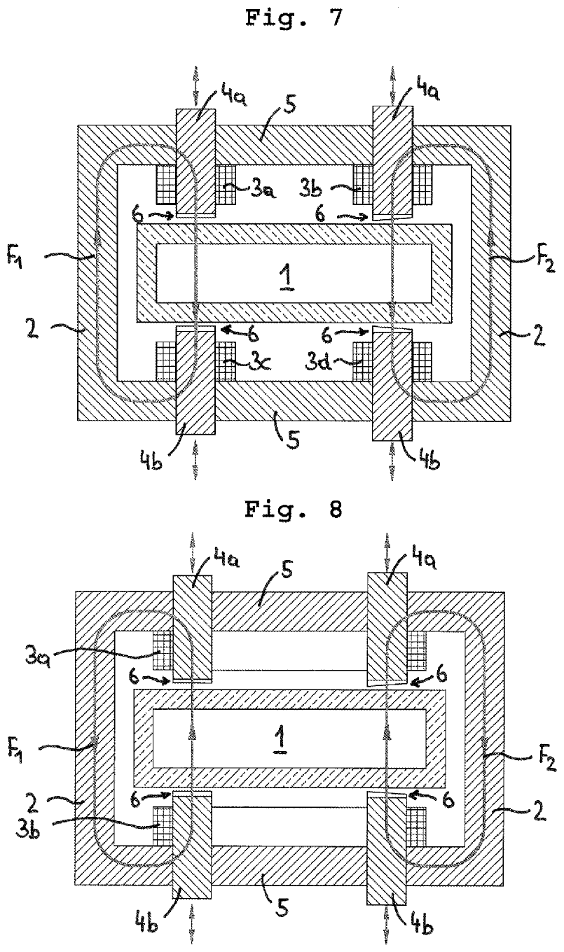

The embodiments of FIGS. 7 and 8 correspond to the embodiments of FIGS. 5 and 6, except that pole heads 6 are arranged between the poles 4a, 4b of a magnetic circuit F₁, F₂ and the mold 1. In addition, the field lines F₁, F₂ in FIG. 8 run in opposite directions to the field lines F₁, F₂ of FIG. 6. By means of the pole head 6, the magnetic flux density inside the mold 1 can be selectively changed, wherein a larger distance between the pole head 6 and the molten steel reduces the magnetic flux density and a smaller distance between the pole head 6 and the molten steel increases the magnetic flux density. The pole head 6 is detachably connected to the pole 4, e.g., via a screw, plug-in or clamp connection.

In FIGS. 4-8, the central regions 5 are magnetically optional, i.e., it makes no difference to the magnetic field whether they are present or not. Nevertheless, the central regions 5 may be preferred for mechanical reasons or to guide the yokes.

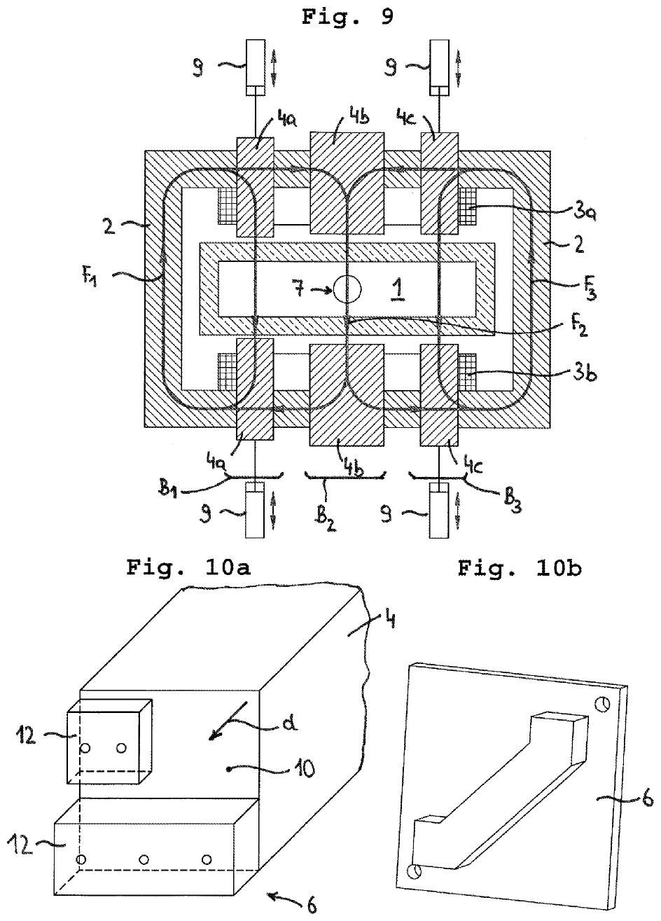

FIG. 9 shows a fifth embodiment of the electromagnetic brake according to the invention. In this embodiment, three magnetic circuits, represented by the field lines F₁, F₂ and F₃, are impressed so that the molten steel emerging from a submerged entry nozzle 7 is braked to a different extent in a central region B₂ than in the lateral regions B₁, B₃, which are arranged to the left or right of the central region B₂. The magnetic field lines F₁ . . . F₃ are impressed only by two coils 3a, 3b. Three poles 4a, 4b, 4c are arranged in each of the coils 3a, 3b shown above and below. The middle poles 4b are designed to be non-displaceable; the poles 4a, 4c arranged to the left and right of them are displaceable by actuators 9. Of course, the middle pole 4b or the middle poles can also be designed to be displaceable. As shown, the middle poles 4b are wider than the side poles 4a, 4c. It is possible that all poles 4a. . . 4c are of equal width or that the lateral poles 4a, 4c are wider than the middle poles 4b.

It is also possible to equip individual, several or also all poles with pole heads in the embodiment according to FIG. 9. The (local) field strength can again be set via a pole head or the pole heads.

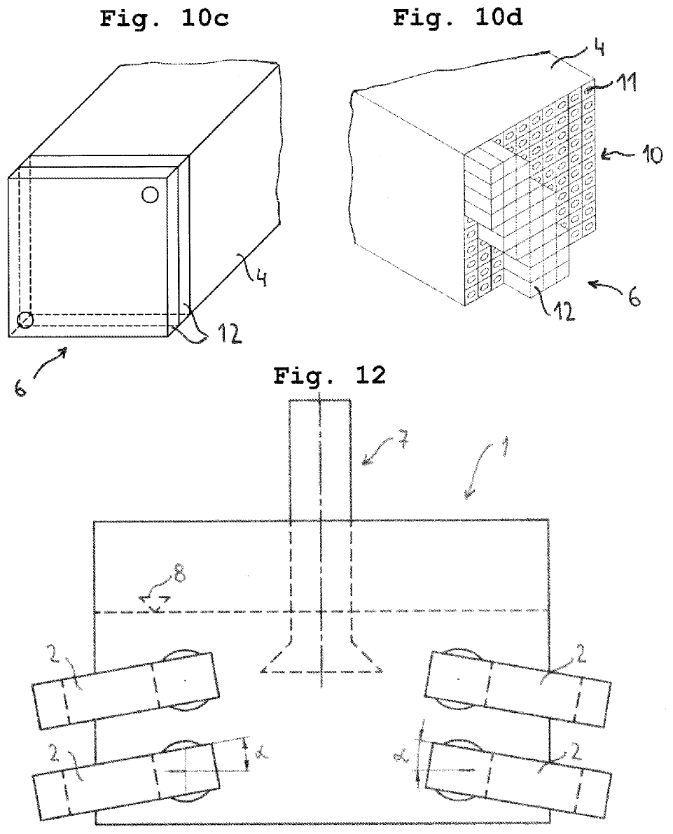

FIGS. 10a to 10d each show a pole head 6; the pole heads of FIGS. 10b and 10c are detachably connected to a pole 4 by screw connections.

FIG. 10a shows a pole head 6 formed by two elements 12. The elements 12 are detachably connected to the pole 4 by screw connections. By way of example, the upper element 12 extends less far in the thickness direction d of the mold than the lower element 12. It is not necessary that the elements 12 completely cover the end face 10 of the pole 4. The elements 12 have the effect that the local magnetic flux density, for example, is higher in the region of the lower element than in the region of the upper element, because the air gap between the upper element and the mold is larger than between the lower element and the mold. Since local differences in the magnetic flux density also locally influence the flow in the mold, pole heads are a good means to be able to locally influence flows in the mold. The elements 12 are made of low-carbon steel.

FIG. 10b shows an arc-shaped pole head 6. The shape of the pole head 6 can be used to adjust the local flux density.

FIG. 10c shows a pole head 6 in which two elements 12 are arranged one above the other and are connected to the pole 4.

FIG. 10d shows a pole head 6 formed from a plurality of rod-shaped, discrete elements 12. The elements 12 can be mechanically connected to the end face 10 of the pole 4 so that the pole head 6 can form different shapes (compare the plugging of Lego bricks onto a base plate). Specifically, the elements 12 can be inserted into slots 11 and secured.

Depending on the application, it is possible to place no pole head or one or more elements 6 of the same or different length on a pole 4. In addition, it is possible to arrange pole heads on the end face 10 of the pole 4 and/or at the right or left or the upper or lower peripheral edge of the pole. This allows the distribution of the magnetic field in the mold or the flux density acting on the molten steel to be adapted to existing requirements.

FIG. 11 shows a front view and a plan view of a mold 1 with two electromagnetic brakes arranged one above the other in the height direction h. As already described further above, molten steel is fed into the mold 1 via a submerged entry nozzle 7. As melt is fed to the mold 1 via the submerged entry nozzle 7 and at the same time the partially solidified strand formed in the mold 1 is withdrawn from the mold, a generally constant casting level 8 is formed. In the first width region B₁, a magnetic field F₁ is introduced by the coils 3a, 3c and the poles 4a, 4b associated with the coils. The magnetic field is closed via the left yoke 2. The magnetic flux density F₁ can be set on the one hand by the current applied and the number of turns in the coils 3a, 3c and on the other hand by displacing the pole 4a by the actuator 9. The same applies for the second width region B₂ and the magnetic flux density F₂. Accordingly, the braking effect on the flow of the melt emerging from the submerged entry nozzle 7 can be set separately for both width regions B₁, B₂ of the mold 1.

By arranging a plurality of electromagnetic brakes one above the other, the flow of the molten steel can be variably influenced at different heights below the casting level.

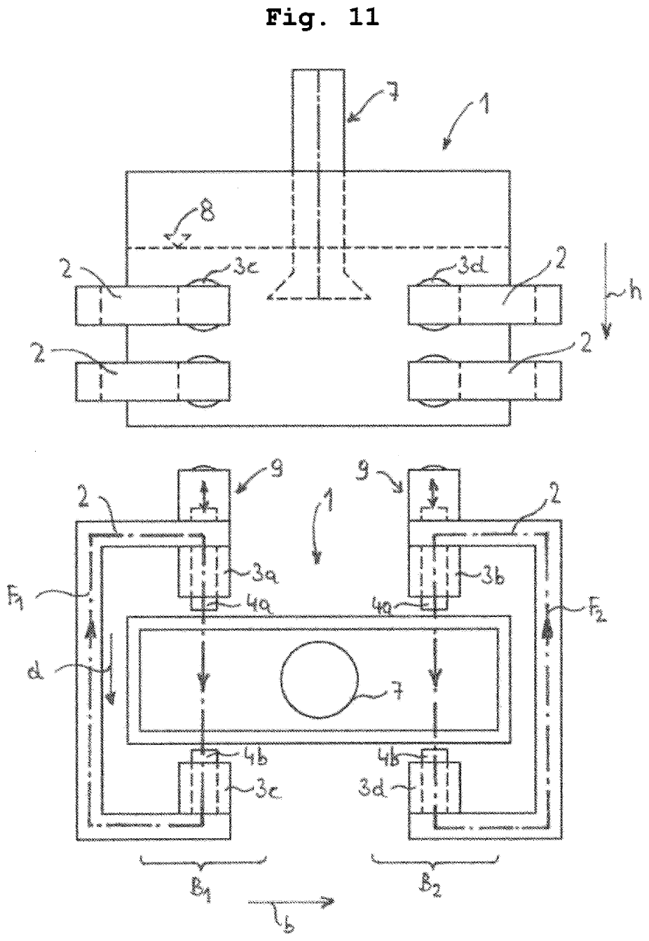

FIG. 12 shows an alternative arrangement to the front view of FIG. 11, wherein an acute angle α, here an angle α=10°, is set between the yokes 2 and the casting level 8. This allows the electromagnetic brake to be accommodated in the machine head of the continuous caster in an even more space-saving manner.

### LIST OF REFERENCE SIGNS

1 mold

2 yoke

3a. . . 3d coil

4, 4a, 4b, 4c pole

5 central region

6 pole head

7 submerged entry nozzle

8 casting level

9 actuator

10 end face

11 hole

12 element

b width direction of the mold

B₁, B₂, B₃ width region of the mold

d thickness direction of the mold

F, F₁, F₂, F₃ magnetic field line

h height direction of the mold

α angle of inclination

1-13 (canceled)

14. An electromagnetic brake for variably influencing the flow of a molten steel in a first width region and a second width region of a mold of a slab continuous casting assembly, said electromagnetic brake comprising:
a first magnetic circuit for influencing the flow in the first width region of the mold;
a second magnetic circuit for influencing the flow in the second width region of the mold, wherein the second width region is offset from the first width region in the width direction of the mold; and
at least one coil for introducing a magnetic flux into the first magnetic circuit and the second magnetic circuit,
wherein the first and second magnetic circuits each comprises, a first pole,
a second pole, and
a yoke for magnetic connection of the first pole and the second pole,
wherein the first and the second poles are opposite in the thickness direction of the mold, and the first pole extends in the thickness direction toward the second pole, and vice versa,
wherein at least one pole of the first magnetic circuit or the second magnetic circuit is displaceable relative to the yoke of the same magnetic circuit in the thickness direction of the mold,
wherein an actuator for displacing a pole in the thickness direction of the mold during operation is provided, and
wherein at least one pole of the first magnetic circuit or the second magnetic circuit has a pole head, which is detachably connected to the pole.

15. The electromagnetic brake as claimed in claim 14, wherein the first and the second magnetic circuits comprise at least one energizable coil.

16. The electromagnetic brake as claimed in claim 15, wherein the first and the second magnetic circuits comprise two separately energizable coils.

17. The electromagnetic brake as claimed in claim 14, wherein the pole head extends in some sections in the width direction and/or the height direction of the mold to a different extent in the thickness direction of the mold.

18. The electromagnetic brake as claimed in claim 14, wherein a longitudinal extension in the thickness direction of the mold of a pole head of the first magnetic circuit is different from a longitudinal extension of a pole head of the second magnetic circuit.

19. The electromagnetic brake as claimed in one of claims 14, wherein the pole head is formed from one or more discrete elements, and wherein the discrete elements are mechanically connected to the pole.

20. The electromagnetic brake as claimed in claim 14, wherein the yoke is arranged in the thickness direction of the mold.

21. The electromagnetic brake as claimed in claim 14, comprising at least two coils for introducing a magnetic flux into the first magnetic circuit and the second magnetic circuit.

22. The electromagnetic brake as claimed in claim 14, wherein at least one pole of the first magnetic circuit and the second magnetic circuit is displaceable relative to the yoke of the same magnetic circuit in the thickness direction of the mold.

23. The electromagnetic brake as claimed in claim 14, wherein at least one pole of the first magnetic circuit and the second magnetic circuit has a pole head, which is detachably connected to the pole.

24. A mold comprising: a first electromagnetic brake as claimed in claim 14, and a second magnetic brake which has a height offset from the first magnetic brake.

25. A method for variably influencing the flow of a molten steel in a first width region and a second width region of a mold during operation of a slab continuous casting assembly by means of an electromagnetic brake as claimed in claim 14, wherein the first and the second magnetic circuit each comprise at least one separately energizable coil, the method comprising:
introducing a first magnetic flux into the first magnetic circuit by energizing a first coil with a first current, thereby influencing the flow in the first width region, and
introducing a second magnetic flux into the second magnetic circuit by energizing a second coil with a second current, thereby influencing the flow in the second width region,
wherein the first current is of a different strength than the second current,
wherein at least one pole of the first or second magnetic circuit is displaceable relative to the mold in the thickness direction thereof, and
wherein an air gap between a pole or a pole head and the mold in the first magnetic circuit is set to be of a different size than an air gap between a pole or a pole head and the mold in the second magnetic circuit.

26. The method as claimed in claim 25, further comprising:
detecting flow velocities of the molten steel in the first and second width regions of the mold;
if the flow velocity in the first width region is higher than in the second width region:
increasing the magnetic flux density in the magnetic circuit associated with the first width region, or
reducing the magnetic flux density in the magnetic circuit associated with the second width region, or
increasing the magnetic flux density in the magnetic circuit associated with the first width region, and
reducing the magnetic flux density in the magnetic circuit associated with the second width region.

27. The method as claimed in claim 25, wherein at least one pole of the first magnetic circuit and the second magnetic circuit is displaceable relative to the mold in the thickness direction thereof.
